(19) United States
(12) Patent Application Publication
(10) Pub. No.: US 2009/0270096 A1
(43) Pub. Date: Oct. 29, 2009

(54) METHOD AND APPARATUS FOR DETECTING CLOSED SUBSCRIBER GROUP CELLS

(75) Inventors: Shankar Somasundaram, Deer Park, NY (US); Rajat P. Mukherjee, Stanford, CA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/428,043

(22) Filed: Apr. 22, 2009

Related U.S. Application Data
(60) Provisional application No. 61/048,434, filed on Apr. 28, 2008.

(51) Int. Cl. H04W 60/00

(52) U.S. Cl. 455/434

(57) ABSTRACT

A method and a wireless transmit/receive unit (WTRU), including a universal subscriber identity module (USIM), for identifying, detecting and accessing a closed subscriber group (CSG) cell are disclosed. The WTRU receives a broadcast from a cell including a cell identifier (ID). If the cell ID is associated with a CSG cell, the WTRU determines whether the CSG ID is programmed in the USIM. The cell broadcast may include a single bit information element (IE) indicating that the cell is a CSG cell. The cell broadcast may further include a bit indicating whether the CSG cell is public or private. Different detection and access methods are also provided for detecting public and private CSG cells. Mobility detection methods for the WTRU in the CSG cell are also provided.

### CROSS REFERENCE TO RELATED APPLICATIONS

This application claims the benefit of U.S. Provisional Application No. 61/048,434 filed Apr. 28, 2008, which is incorporated by reference as if fully set forth.

This application is also related to U.S. patent application Ser. No. 12/105,574 filed Apr. 18, 2008, which is incorporated by reference as if fully set forth.

### FIELD OF INVENTION

This application is related to wireless communications.

### BACKGROUND

A goal of the third generation partnership project (3GPP) long term evolution (LTE) program is to develop new technology, new architecture and new methods for LTE settings and configurations in order to provide improved spectral efficiency, reduced latency, and better utilization of radio resources for faster user experiences and richer applications and lower cost services. As part of these efforts, the 3GPP has introduced the concept of an in-home evolved Node-B (HeNB) for LTE networks, (commonly referred to as femtocells). 3GPP is also considering an in-home Node-B (HNB) for release 8 (R8) wideband code division multiple access (WCDMA).

A femtocell is a very small base station, and may be placed in areas where there is a premium on space, such as a residence or inside a shopping mall. Benefits of use of femtocells for mobile operators are readily apparent, such as improving coverage in a cost effective manner and offloading macro radio network facilities.

The HeNB refers to a physical device that may be similar to a wireless local area network (WLAN) access point (AP). The HeNB provides users with access to LTE services over extremely small service areas, such as homes or small offices. The HeNB is intended to connect to the operators' core network by using, for example, the public internet connections available freely today at homes across the country, (e.g., digital subscriber line (DSL)). This can be particularly useful in areas where LTE has not been deployed, and/or in areas where legacy 3GPP radio access technology (RAT) coverage already exists. This may also be useful in areas where LTE coverage may be faint or non-existent due to, for example, the occurrence of radio transmission problems in an underground metro or a shopping mall.

An HeNB closed subscriber group (CSG) cell is a defined area over which radio coverage provided by the HeNB may only be accessed by a group of subscribers authorized to use the services of the cell. The CSG may be a family or anyone in the vicinity of a particular location, (e.g., anyone in a coffee shop), who attempts to access the HeNB CSG cell. An HeNB may typically be used to deploy one or more CSG cells over an area over which LTE coverage is desired. A CSG cell may be deployed by an HeNB for LTE services, or for WCDMA or for other legacy 3GPP RAT services. The subscriber, whether an individual or an organization, may deploy a CSG cell using an HeNB over an area where such service is desired.

FIG. 1 shows an example of a conventional HeNB deployment in a wireless communication system 100. The wireless communication system 100 includes an LTE macro-cell 105, a 3GPP system cell 110, a higher network node (e.g., gateway) 115 and/or a mobility management entity (MME)/serving general packet radio service (GPRS) support node (SGSN) 120. The higher network node 115 is responsible for coordinating the operation of several HeNBs 125A, 125B and 125C. Alternatively, the MME/SGSN 120 may be responsible for coordinating the operation of several HeNBs 125A, 125B and 125C. The MME is the LTE equivalent of a 3G/2G SGSN. The relationship between the LTE macro-cell 105 and the 3GPP system 110, (e.g., WCDMA/global system for mobile communications (GSM)), is that there may be areas where the coverage of these two technologies overlap. It is similar to simultaneous coverage of GSM and WCDMA technologies. The relationship of the LTE macro-cell 105 and the 3GPP system cell 110 with the higher network node 115 is ambiguous. In all likelihood, the higher network node 115 is likely to be a gateway function which interfaces with the MME/SGSN 120. As a gateway, the role of the higher network node 115 may be to act as a single macro-cell towards the MME/SGSN 120 while supporting several small home cells.

As pointed out in U.S. patent application Ser. No. 12/105,574, filed on Apr. 18, 2008 and incorporated herein by reference, the determination of access to a CSG cell may be based on a CSG indication, (e.g., a one bit indication of whether or not a cell is a CSG cell), on a broadcast channel, combined with the configuration of the CSG identifiers (IDs), (broadcast by the CSG cell), a wireless transmit/receive unit (WTRU) has access to in a white-list, (optionally stored in a universal subscriber identity module (USIM)).

However, the time that is required by a WTRU in an idle mode or in a connected mode to determine whether a cell is a CSG is problematic, because the CSG indication and the CSG ID is obtained from system information provided over a broadcast channel, and the WTRU needs to acquire this channel prior to making such a determination.

A further problem may arise depending on the use case of the CSG cells. Operators may wish to deploy CSG cells for coverage extension purposes, (e.g., in underground railway stations). They may wish to offer such services to only paying customers. In either case, such a CSG cell may be viewed as a public CSG cell. This is different from a private CSG cell deployed by a family intended for use by a few family members only. The difference is that from the network perspective many more users might subscribe to a public reserved cell than a private reserved cell, (i.e., the CSG may be much larger for a public cell than a private cell). From the terminal perspective, the list of public CSG cells it has access to may be much larger than the list of private CSG cells it has access to. The problem that may occur is that to configure the WTRU with a white-list for public CSG cells may be difficult.

### SUMMARY

A method and apparatus for detecting public and private CSG cells is described herein. A CSG cell is identified by a CSG identifier and which may be detected by a WTRU. Methods are also provided wherein WTRUs can be configured to be allowed to access public CSG cells for enabling differentiated service offerings for users. Methods for WTRU mobility detection in CSGs, measurement gaps in detection, and determining rights of accessing and measuring private CSG cells are also described.

### BRIEF DESCRIPTION OF THE DRAWINGS

A more detailed understanding may be had from the following description, given by way of example in conjunction with the accompanying drawings wherein:

FIG. 1 shows an example of a conventional HeNB deployment in a wireless communication system; and

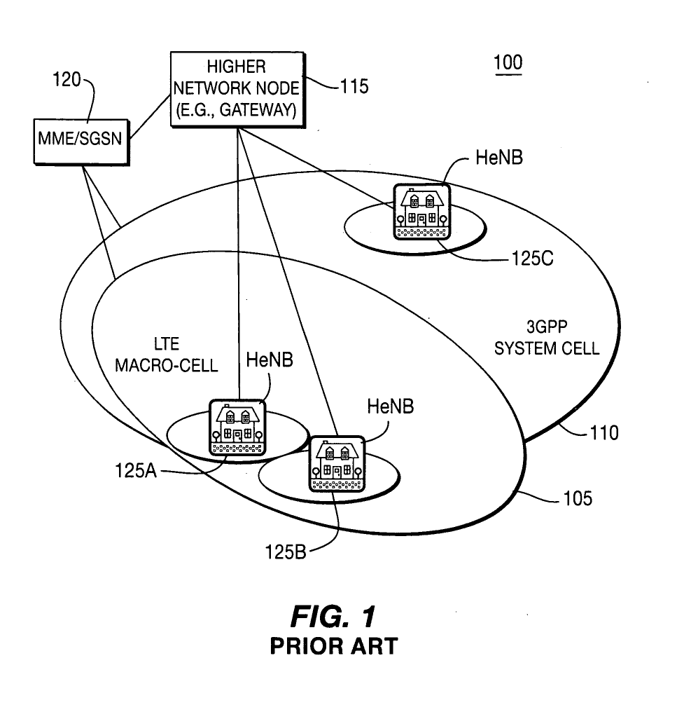

FIG. 2 is an example of a block diagram of a WTRU that is configured to receive cell broadcasts and identify CSG cells.

### DETAILED DESCRIPTION

When referred to hereafter, the terminology “wireless transmit/receive unit (WTRU)” includes but is not limited to a user equipment (WTRU), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to an evolved Node-B (eNodeB), a site controller, an access point (AP), or any other type of interfacing device capable of operating in a wireless environment.

The details of the methods and apparatus as provided herein may be adapted with appropriate modifications to other wireless standards such as WCDMA, global system for mobile communications (GSM)/enhanced data rates for GSM evolution (EDGE) radio access network (GERAN), code division multiple access 2000 (CDMA2000), worldwide interoperability for microwave access (WiMAX), and the like, with suitable modifications.

Identification of a CSG should be performed on a cell-level. Thus, the WTRU should be able to identify the specific CSG it has access to, based on a CSG ID stored either externally, (e.g., in an HeNB accessible by the WTRU), or in the WTRU, (e.g., programmed in a USIM residing in a universal integrated circuit card (UICC) or LTE equivalent in the WTRU, or programmed using any other application on the UICC).

The CSG ID may be the tracking area (TA) the CSG cell belongs to. This TA may be different from the TA the macro-cell belongs to, in which case it is referred to as a CSG TA.

The CSG ID may be any ID that identifies the CSG that the WTRU has access to globally. Alternatively, the CSG ID may be a globally unique cell ID of the CSG cell. Also, the CSG ID may be an HeNB ID of the HeNB that is broadcasting a CSG cell, or a combination of a TA ID, a cell ID and an HeNB ID. The CSG ID may have a unique format/length as compared to the equivalent cell ID for the macro-cell.

Thus, the WTRU is able to determine that this cell is a CSG cell. Every time the WTRU detects a cell, the WTRU determines whether the ID broadcast is a CSG ID and, if so, the WTRU determines whether this CSG ID is programmed in the USIM or LTE equivalent in the WTRU. If this CSG ID is programmed in the WTRU, the WTRU may consider this CSG cell as being suitable for access. This procedure may be performed even if the CSG ID is a TA ID that the CSG cell belongs to.

Alternatively, an information element (IE) may be added to the broadcast, which may be as small as 1 bit, to indicate that the cell is a CSG cell. A CSG cell would thus distinguish itself from a macro-cell by setting this bit. A macro-cell would also broadcast this bit but not set it. A WTRU may determine that a cell is a CSG cell by reading the 1-bit indication on the cell broadcast and determining its value. In the event that the bit is set and the cell is therefore a CSG cell, in order to determine whether or not it has access to this CSG cell, the WTRU will check its USIM or LTE equivalent, (any other application on the UICC), to see whether the CSG ID programmed matches the CSG ID broadcast by the CSG cell. Only WTRUs with that particular CSG ID programmed in their USIM, or LTE equivalent, can access that particular CSG cell. The CSG ID may be identical to that of a WCDMA CSG cell.

Although using a cell ID as the CSG ID addresses the problem of access control to a correct CSG cell, it does not eliminate the need for a large set of unique cell-level CSG IDs. Furthermore, in LTE_idle mode, a WTRU is known to a network at a TA-level only. If the CSG cell belongs to the TA of the surrounding macro cell, (i.e., if CSG cells do not have their own TA which is separate from the one a macro-cell belongs to), the WTRU in LTE_idle mode will be paged across all macro cells and CSG cells in that TA, possibly leading to an unnecessary paging load. In order to overcome this problem, the network may adopt a paging method that pages the WTRU first in the CSG cell that the WTRU accessed most recently. The network may then page the neighboring CSG cells to which the WTRU has access. This may occur in the TA in which the last TA update (TAU) request was received and assumes that the network possesses geographical knowledge that may be maintained about the position of the CSG cells the WTRU has access to in relation to the TAs. The page may then spread out to surrounding macro-cells and then to other TAs in which the WTRU may have been assigned.

A user may configure whether the CSG cell is to be public or private. The user may also configure other CSG cell parameters, such as services offered. This may be done manually on the HeNB with, for example, a switch, as an Internet protocol (IP)-level command. For example, the HeNB may have a user interface which may be accessed on a sub-network by using the IP address assigned to the HeNB by the router of that sub-network, using non-access stratum (NAS)/radio resource control (RRC) messages, or by contacting the operator and having the operator configure the CSG cell parameters on the HeNB as part of its operations and maintenance (O&M) procedures. The user may also be able to configure the specific WTRUs that are allowed access on the CSG cell and the services they are granted. This again may be a part of operator O&M procedures or through the schemes described above. If the scheme of implicitly using the presence of a CSG ID to indicate public or private access is used, the CSG cell preferably is configured as public. It would need to acquire a distinct CSG ID from an operator as part of its configuration procedures.

A decision regarding access to the CSG cell may be made in the network, based, for example, on service, subscription policies, and the like. The WTRU preferably knows which CSG cells it has access to. It may get this information from the network. These CSG cells may be the private CSG cells subscribed to or the WTRU may request CSG cells offering public access for certain services. The WTRU may obtain this information by means of a pull-mechanism, whereby the WTRU sends a signal asking the network which CSG cells exist in the nearby area that it is allowed to access. This signal may include the reason for access which may indicate the services desired. The network preferably responds with a list of appropriate CSG IDs. The WTRU can only reselect/handover to a CSG cell in this list. Alternatively the network can, on its own, send such a list to the WTRU. In another alternative, when a WTRU moves between cells or TAs, upon sending a TAU/cell update message to the network, the network can respond with a list of CSG cells that the WTRU is allowed to access in this TA or near such a cell. The contents of the messages may take the form of dedicated signaling or may be included as part of existing mechanisms, for example, a TAU request. The public CSG cells may be indicated to all WTRUs in the area in the cell-broadcast or, particularly if the list is large, a subset of them may be indicated to individual users by RRC or NAS signaling.

Alternatively, a logical entity within an operator core network may make the access restriction decision. For example, the functional entity may be the 3GPP authentication, authorization, and access (AAA) server or home subscriber server (HSS), and the HeNB may implement a client program that downloads the relevant WTRU subscriptions upon triggering by an appropriate event, (e.g., a WTRU requesting access). A WTRU does not need to make the decision of which CSG cells are appropriate. The WTRU may implement a client application that pulls the relevant information from the network or CSG cell by appropriate signaling.

Determining Right of Accessing and Measuring Public CSG Cells

A WTRU may use the following possible options to detect a public CSG.

The WTRU may detect that the cell is using a physical layer cell ID (PCID) or a scrambling code reserved for public CSG cells, or detect that the cell is using a PCID or a scrambling code reserved for CSG cells.

Alternatively, the WTRU may detect that the cell is using a public CSG-cell specific cyclic redundancy check (CRC) attachment, or that the cell is using a CSG-cell specific CRC attachment.

The WTRU may also use an indication on the broadcast channel, (e.g., a one bit indication or an ID or some kind of enumerated variable, such as true/false).

Alternately, the WTRU detects that the cell is on a different frequency known to be for CSG cells, or that the cell is on a different frequency known to be for public CSG cells, or that the cell is not on a frequency known to be for private CSG cells, or that the cell is on the same frequency as a macro-cell.

The WTRU can then determine that it can access and/or measure the public CSG cell if at least one of the following conditions holds:

1) If the PCID/scrambling code used by the public CSG cell is configured in the WTRU;

2) The cell is not barred;

3) The cell belongs to a TA that is not forbidden;

4) The cell belongs to a public land mobile network (PLMN) that is not forbidden;

5) The cell is on the same frequency as a macro-cell;

6) The cell is not on a frequency dedicated for CSG cells/private CSG cells;

7) The WTRU is configured to access public CSG cells;

8) If an ID broadcast by the CSG cell (e.g., CSG ID) is included in the white-list of CSG cells the WTRU has access to; and

9) If some other ID broadcast by the public CSG cell, (e.g., coverage extension cell ID), is configured in the WTRU for this purpose.

It is possible that some WTRUs are required be configured to be allowed to access public CSG cells. This may be done to enable differentiated service offerings for users. This configuration may be specific to RAT or frequency or location, (e.g., cell/TA/location area (LA)/routing area (RA)). Specifically it is proposed that a WTRU configured to access public CSG cell, (either by default or using the method outlined), may not check that the CSG ID broadcast by the public CSG cell matches any entry stored in its white-list. Furthermore, it is also possible that the network operator, through at least one open mobile alliance (OMA) mechanism, configures all the public HNBs in a particular PLMN to be accessible by all WTRUs. Alternatively, the WTRU may access a public HNB after detection. The network operator might then override the ability of the WTRU to access public HNBs by an OMA mechanism, or by any other mechanism.

The configurable parameters proposed above, (e.g., reserved PCIDs, frequency info, access to public CSG cells, CSG IDs, and the like), may be performed independently via at least one of broadcast signaling, dedicated signaling (RRC/NAS), short message service (SMS), pre-configured WTRU manufacturer information, OMA device management, and white-list configuration of CSG cells.

Determining Right of Accessing and Measuring Private CSG cells

A WTRU can detect a private CSG cell using at least one of the following options:

1) Detecting that the cell is using a PCID/scrambling code reserved for private CSG cells or detecting that the cell is using a PCID/scrambling code reserved for CSG cells;

2) Detecting that the cell is using a private CSG-cell specific CRC attachment or that the cell is using a CSG-cell specific CRC attachment;

3) Detecting an indication on the broadcast channel, (e.g., one bit indication or an ID or some kind of enumerated variable such as true/false;

4) Detecting that the cell is on a different frequency layer known to be for CSG cells or that the cell is on a different frequency layer known to be for private CSG cells or that the cell is not on a frequency layer known to be for public CSG cells; and

6) Detecting that the cell is on the same frequency as a macro-cell.

The WTRU can then determine that it can access and/or measure the private CSG cell if at least one of the following conditions holds:

1) The cell is not barred;

2) The cell belongs to a Tracking Area that is not forbidden;

3) The cell belongs to a PLMN that is not forbidden;

4) The cell is on the same frequency as a macro-cell;

5) The cell is not on a frequency dedicated for macro-cells/public CSG cells;

6) The WTRU is configured to access private CSG cells;

7) If an ID broadcast by the CSG cell (e.g. CSG ID) is included in the white-list of CSG cells the WTRU has access to; and

8) If the PCID/scrambling code used by the Private CSG cell is configured in the WTRU.

The configurable parameters proposed above, (e.g. reserved PCIDs, frequency info, access to public CSG cells, CSG IDs, and the like), may be performed independently via at least one of broadcast signaling, dedicated signaling (RRC/NAS), SMS, pre-configured WTRU manufacturer information, OMA device management, and white-list configuration of CSG cells.

Mobility Detection

A WTRU can determine its mobility state by counting at least one of the following:

1) The number of re-selections performed to cells;

2) The number of handover performed to cells; and

3) The number of cells detected.

The WTRU applies a certain algorithm/factor for macro-cells and applying a different algorithm/factor if the cell detected is a femtocell/CSG cell, the femtocell/CSG cell being distinguished from the macro-cell by at least one of:

1) reserved PCID/scrambling code;

2) a CSG-cell specific CRC attachment;

3) an indication on the broadcast channel, (e.g., a one bit indication or an ID); and

4) being on a different frequency layer known to be for femtocells.

Once the WTRU detects that the cell it has detected is a CSG cell, (e.g., by reading a one bit CSG indication or some enumerated variable (true: CSG; false: non-CSG), on the broadcast channel), the WTRU may decide to modify its mobility parameters accordingly. As an example, for a CSG cell, it might decide to apply the speed detection and time-to-trigger (TTT) modification parameters differently.

It is also proposed that the WTRU may disregard altogether a femtocell/CSG cell (detected using at least one of the methods described above) for purposes of determining its mobility.

It is also proposed that any subset of the procedures defined above may be selectively applied to public CSG cells and private CSG cells.

It is proposed that the configurable parameters described above, (e.g., algorithm/factor used, PCID/scrambling code, femtocell frequency, and the like), may be independently configured in the WTRU using at least one of broadcast signaling, dedicated signaling (RRC/NAS), SMS, pre-configured WTRU manufacturer information, OMA device management, and white-list configuration of CSG cells.

Measurement Gap Configuration

A WTRU in connected mode may need several measurement gaps to identify the CSG cell it has access to since it may have to acquire the broadcast information of the CSG cell. In active mode the WTRU may autonomously determine the presence of a nearby CSG cell or it may be manually commanded to search for a cell.

It is proposed that the WTRU may then prioritize this search during the next measurement/discontinuous reception (DRX) gap, regardless of whether the measurement gap was configured by the network for intra-frequency/inter-frequency/inter-RAT measurements or whether triggers for intra-frequency/inter-frequency/inter-RAT measurements are met, that is, WTRU can prioritize its CSG measurements irrespective of the actual measurement gap purpose that was signaled. In the measurement report WTRU can indicate that incomplete measurements for intra-frequency/inter-frequency/inter-RAT measurements were due to CSG search.

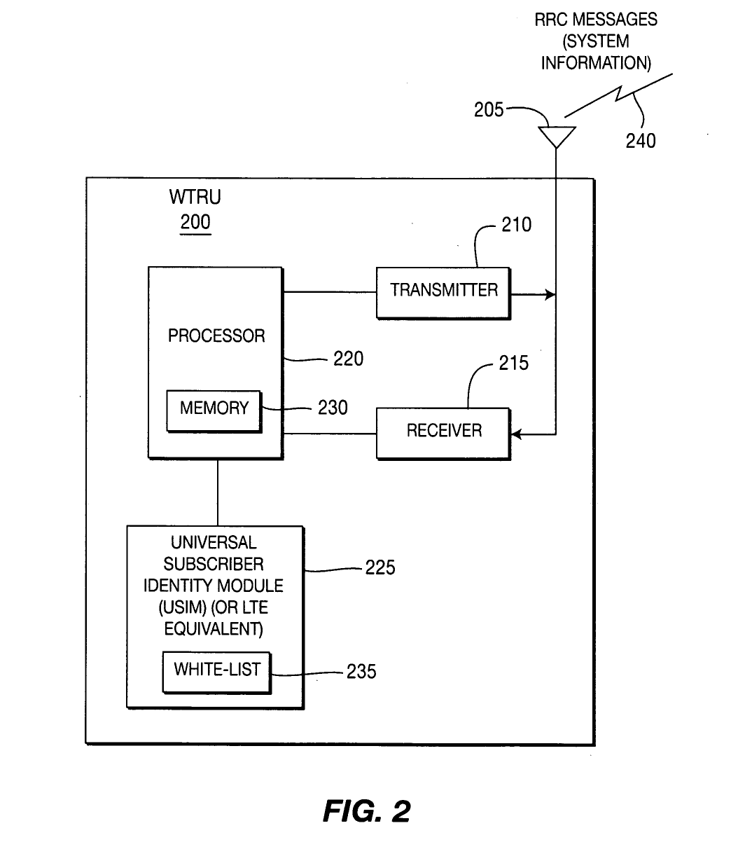

FIG. 2 is an example of a block diagram of a WTRU 200 that is configured to receive cell broadcasts and identify CSG cells. The WTRU 200 includes an antenna 205, a transmitter 210, a receiver 215, a processor 220 and a USIM (or LTE equivalent) 225. The processor 220 includes a memory 230. The USIM (or LTE equivalent) 225 includes a CSG white-list 235 and may reside in a UICC (not shown). The receiver 215 is configured to receive RRC messages (system information) 240 via the antenna 205 from a cell in a network. The processor 220 is electrically coupled to the transmitter 210, the receiver 215 and the USIM (or LTE equivalent) 225. The processor 220 is configured to determine whether the cell ID is associated with a CSG cell and, if so, determine whether the CSG ID is programmed in the USIM 225.

Referring to FIG. 2, the WTRU 200 may detect CSG cells by using the receiver 215 to receive system information 240 that indicates at least one PCID reserved for a CSG cell. The processor 220 stores the system information in the memory 230, and determines that a detected cell is a CSG cell on a condition that the detected cell has a PCID reserved for a CSG cell that is included in the stored system information. The CSG cell may be a public CSG cell or a private CSG cell.

Alternatively, the WTRU 200 may detect CSG cells by using the receiver 215 to receive system information 240 that indicates at least one scrambling code reserved for a CSG cell. The processor 220 stores the system information in the memory 230, and determines that a detected cell is a CSG cell on a condition that the detected cell has a scrambling code reserved for a CSG cell that is included in the stored system information. Again, the CSG cell may be a public CSG cell or a private CSG cell.

Alternatively, the WTRU 200 may detect CSG cells by using the receiver 215 to receive system information 240 that indicates at least one frequency associated with a CSG cell. The processor 220 stores the system information in the memory 230, and determines that a detected cell is a CSG cell on a condition that the detected cell communicates over a frequency associated with a CSG cell that is included in the stored system information. Again, the CSG cell may be a public CSG cell or a private CSG cell.

Alternatively, the WTRU 200 may detect CSG cells by using the receiver 215 to receive system information that indicates whether or not a detected cell is a public CSG cell. The USIM 225 stores a CSG white-list 235. The processor 220 is configured to check the CSG white-list 235 on a condition that the detected cell is determined not to be a public CSG cell. However, the CSG white-list 235 is not checked by the processor 220 on a condition that the detected cell is determined to be a public CSG cell.

The WTRU 200 may also be configured to adjust mobility parameters associated with a CSG cell. The processor 220 determines whether or not a detected cell is a CSG cell, and modifies mobility parameters stored in the memory 230 on a condition that the detected cell is a CSG cell. The mobility parameters may include at least one of a speed detection parameter and a TTT parameter.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (WTRU), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method implemented by a wireless transmit/receive unit (WTRU) for detecting closed subscriber group (CSG) cells, the method comprising:
receiving, at a receiver in the WTRU, system information that indicates at least one physical layer cell identity (PCID) reserved for a CSG cell;
storing the system information in a memory of the WTRU; and
determining, at a processor in the WTRU, that a detected cell is a CSG cell on a condition that the detected cell has a PCID reserved for a CSG cell that is included in the stored system information.

2. The method of claim 1 wherein the CSG cell is a public CSG cell.

3. The method of claim 1 wherein the CSG cell is a private CSG cell.

4. A method implemented by a wireless transmit/receive unit (WTRU) for detecting closed subscriber group (CSG) cells, the method comprising:
receiving, at a receiver in the WTRU, system information that indicates at least one scrambling code reserved for a CSG cell;
storing the system information in a memory of the WTRU; and
determining, at a processor in the WTRU, that a detected cell is a CSG cell on a condition that the detected cell has a scrambling code reserved for a CSG cell that is included in the stored system information.

5. The method of claim 4 wherein the CSG cell is a public CSG cell.

6. The method of claim 4 wherein the CSG cell is a private CSG cell.

7. A method implemented by a wireless transmit/receive unit (WTRU) for detecting closed subscriber group (CSG) cells, the method comprising:
receiving, at a receiver in the WTRU, system information that indicates at least one frequency associated with a CSG cell;
storing the system information in a memory of the WTRU; and
determining, at a processor in the WTRU, that a detected cell is a CSG cell on a condition that the detected cell communicates over a frequency associated with a CSG cell that is included in the stored system information.

8. The method of claim 7 wherein the CSG cell is a public CSG cell.

9. The method of claim 7 wherein the CSG cell is a private CSG cell.

10. A method implemented by a wireless transmit/receive unit (WTRU) for detecting closed subscriber group (CSG) cells, the method comprising:
receiving, at a receiver in the WTRU, system information that indicates whether or not a detected cell is a public CSG cell;
checking a CSG white-list stored in the WTRU on a condition that the detected cell is determined not to be a public CSG cell, and the CSG white-list is not checked on a condition that the detected cell is determined to be a public CSG cell.

11. A method implemented by a wireless transmit/receive unit (WTRU) for adjusting mobility parameters associated with a closed subscriber group (CSG) cell, the method comprising:
determining, at a processor in the WTRU, whether or not a detected cell is a CSG cell; and
the processor modifying mobility parameters stored in a memory on a condition that the detected cell is a CSG cell.

12. The method of claim 11 wherein the mobility parameters include at least one of a speed detection parameter and a time-to-trigger (TTT) parameter.

13. A wireless transmit/receive unit (WTRU) for detecting closed subscriber group (CSG) cells, the WTRU comprising:
a receiver configured to receive system information that indicates at least one physical layer cell identity (PCID) reserved for a CSG cell; and
a processor including a memory, the processor configured to store the system information in the memory, and determine that a detected cell is a CSG cell on a condition that the detected cell has a PCID reserved for a CSG cell that is included in the stored system information.

14. The WTRU of claim 13 wherein the CSG cell is a public CSG cell.

15. The WTRU of claim 13 wherein the CSG cell is a private CSG cell.

16. A wireless transmit/receive unit (WTRU) for detecting closed subscriber group (CSG) cells, the WTRU comprising:
a receiver configured to receive system information that indicates at least one scrambling code reserved for a CSG cell; and
a processor including a memory, the processor configured to store the system information in the memory, and determine that a detected cell is a CSG cell on a condition that the detected cell has a scrambling code reserved for a CSG cell that is included in the stored system information.

17. The WTRU of claim 16 wherein the CSG cell is a public CSG cell.

18. The WTRU of claim 16 wherein the CSG cell is a private CSG cell.

19. A wireless transmit/receive unit (WTRU) for detecting closed subscriber group (CSG) cells, the WTRU comprising:
a receiver configured to receive system information that indicates at least one frequency associated with a CSG cell; and
a processor including a memory, the processor configured to store the system information in the memory, and determine that a detected cell is a CSG cell on a condition that the detected cell communicates over a frequency associated with a CSG cell that is included in the stored system information.

20. The WTRU of claim 19 wherein the CSG cell is a public CSG cell.

21. The WTRU of claim 19 wherein the CSG cell is a private CSG cell.

22. A wireless transmit/receive unit (WTRU) for detecting closed subscriber group (CSG) cells, the WTRU comprising:
a receiver configured to receive system information that indicates whether or not a detected cell is a public CSG cell;
a universal subscriber identity module (USIM) configured to store a CSG white-list; and
a processor configured to check the CSG white-list on a condition that the detected cell is determined not to be a public CSG cell, and the CSG white-list is not checked by the processor on a condition that the detected cell is determined to be a public CSG cell.

23. A wireless transmit/receive unit (WTRU) for adjusting mobility parameters associated with a closed subscriber group (CSG) cell, the WTRU comprising:
a memory configured to store mobility parameters; and
a processor configured to determine whether or not a detected cell is a CSG cell, and modify mobility parameters stored in the memory on a condition that the detected cell is a CSG cell.

24. The WTRU of claim 23 wherein the mobility parameters include at least one of a speed detection parameter and a time-to-trigger (TTT) parameter.
